(19) United States
(12) Patent Application Publication
(10) Pub. No.: US 2025/0359704 A1
(43) Pub. Date: Nov. 27, 2025

(54) Bottle Attachment for a Blender

(71) Applicant: Midea Group Co., Ltd., Foshan (CN)

(72) Inventors: Ryan Persaud, Louisville, KY (US); Matthew Hunter, Louisville, KY (US)

(73) Assignee: Midea Group Co., Ltd., Foshan (CN)

(21) Appl. No.: 18/674,360

(22) Filed: May 24, 2024

(51) Int. Cl. A47J 43/07

(52) U.S. Cl. CPC A47J 43/0722

(57) ABSTRACT

A bottle blender attachment for a blender. The bottle blender attachment may include one or more bottle adapters. The bottle blender attachment may sealingly engage one or more bottles/container. The bottle blender attachment may include one or more sealing mechanisms. The bottle blender attachment may include one or more portions of a blade assembly.

### BACKGROUND

The present embodiments relate to a blender, more specifically for a bottle attachment for blender.

Typically blender containers are made specifically for use with a particular blender. This specific blender container may have a specific opening diameter, limited capacity, and/or limited portability. Thus, there is a need for the user to blend within a variety of bottles or containers (e.g. personal water bottle) of different sizes and/or shapes defining a variety of neck openings/diameters.

### SUMMARY

In some embodiments of the invention, for example, a blender for engaging one or more bottle openings of a variety of inner diameters may include a base having a drive mechanism. In various embodiments, the blender may include a bottle blender attachment configured to engage one or more bottle openings of a variety of inner diameters. In some embodiments, the bottle blender attachment may have a blade assembly and/or a first bottle adaptor. In various embodiments, the blade assembly may releasably engage the drive mechanism of the base. In some embodiments, the blade assembly includes one or more blades. In some embodiments, the first bottle adaptor may include a first sealing mechanism configured to radially engage a first inner diameter of the one or more bottle openings.

In addition, in some embodiments, the blender may include a second bottle adaptor having a second sealing mechanism. In various embodiments, the first sealing mechanism may be configured to radially engage the second bottle adaptor. In some embodiments, the second sealing mechanism may be configured to radially engage a second inner diameter larger than the first inner diameter of the one or more bottle openings. In various embodiments, the first sealing mechanism may be the same as the second sealing mechanism. In some embodiments, the first bottle adaptor may telescope within the second bottle adaptor. In various embodiments, the second bottle adaptor may include an axial stopping mechanism configured to axially stop insertion of the second bottle adaptor into the one or more bottle openings. In some embodiments, the first sealing mechanism may be an O-ring. In various embodiments, the first bottle adaptor may include an axial stopping mechanism configured to axially stop insertion of the first bottle adaptor into at least one of the one or more bottle openings and/or a second bottle adaptor. In some embodiments, the first sealing mechanism may be inflatable. In various embodiments, the first sealing mechanism may be inflated to increase a first outer diameter to a second outer diameter larger than the first outer diameter. In some embodiments, the first sealing mechanism may be compressible. In various embodiments, the first sealing mechanism may be axially compressed to increase a first outer diameter to a second outer diameter larger than the first outer diameter. In some embodiments, the first sealing mechanism may include a conical outer periphery. In various embodiments, the conical outer periphery may narrow in a direction towards the blade assembly.

In some embodiments, a bottle blender attachment for engaging one or more bottle openings of a variety of inner diameters may include a blade assembly configured to releasably engage a drive mechanism of a blender. In various embodiments, a first bottle adaptor may have a first sealing mechanism. In some embodiments, the first bottle adaptor may be positionable between a first configuration and a second configuration. In some embodiments, when in the first configuration the first sealing mechanism may be configured to radially engage a first inner diameter of one or more bottle openings and wherein when in the second configuration the first sealing mechanism may be configured to radially engage a third inner diameter of a second bottle adaptor.

In addition, in some embodiments, the first bottle adaptor may include an axial stopping mechanism to limit axial travel in the first configuration or the second configuration. In various embodiments, the bottle blender attachment may include a second bottle adaptor having a second sealing mechanism. In some embodiments, when in the second configuration the second sealing mechanism may be configured to radially engage a second inner diameter of one or more bottle openings larger than the first inner diameter. In various embodiments, the first bottle adaptor may telescopingly engage the third inner diameter of the second bottle adaptor when in the second configuration. In some embodiments, the second bottle adaptor may include an axial stopping mechanism to limit axial travel of the second bottle adaptor relative to one or more bottle openings. In various embodiments, at least one of the first sealing mechanism and/or the second sealing mechanism may be an O-ring.

In various embodiments, a bottle blender attachment for engaging one or more bottle openings of a variety of inner diameters may include a bottle adaptor. In some embodiments, the bottle blender attachment may include a blade assembly releasably engaging a drive mechanism of a blender. In various embodiments, the bottle adaptor may include at least one sealing mechanism having an outer periphery adjustable between a first configuration and a second configuration. In some embodiments, when in the first configuration the outer periphery of at least one sealing mechanism may include a first outer diameter sealingly engaging an inner diameter of a bottle opening. In various embodiments, wherein when in the second configuration the outer periphery of at least one sealing mechanism includes a second outer diameter, larger than the first outer diameter, sealingly engaging an inner diameter of a bottle opening. In some embodiments, at least one sealing mechanism may be an O-ring, a conical member, a compressible member, or an inflatable member.

In some embodiments, a method of sealing one or more bottle openings of a variety of inner diameters may include providing a bottle blender attachment having a blade assembly releasably engaging a drive mechanism of a blender and a bottle adaptor. In various embodiments, the bottle adaptor may include at least one sealing member having an outer periphery adjustable between a first configuration and a second configuration. In some embodiments, when in the first configuration the outer periphery of at least one sealing member may include a first outer diameter. In various embodiments, when in the second configuration the outer periphery of at least one sealing member may include a second outer diameter larger than the first outer diameter. In some embodiments, the method may include axially inserting the bottle adaptor into a bottle opening having a first inner diameter or a second inner diameter larger than the first inner diameter. In various embodiments, the method may include sealingly engaging the first inner diameter when in the first configuration. In some embodiments, the method may include sealingly engaging the second inner diameter when in the second configuration.

In addition, in some embodiments, the method may include inflating at least one sealing member from the first configuration to the second configuration. In various embodiments, the method may include compressing at least one sealing member from the first configuration to the second configuration. In some embodiments, the method may include axially inserting the bottle adaptor into the bottle opening from the first configuration to the second configuration. In various embodiments, the bottle adaptor may include a first bottle adaptor and a second bottle adaptor. In some embodiments, when in the second configuration the first bottle adaptor sealingly engages the second bottle adaptor and the second bottle adaptor sealingly engages the second inner diameter. In various embodiments, the method may include telescopingly engaging the first bottle adaptor to the second bottle adaptor.

These and other advantages and features, which characterize the embodiments, are set forth in the claims annexed hereto and form a further part hereof. However, for a better understanding of the embodiments, and of the advantages and objectives attained through its use, reference should be made to the Figures and to the accompanying descriptive matter, in which there is described example embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of one embodiment of a blender, and illustrating an embodiment of a bottle blender attachment.

FIG. 2 is an exploded view of the embodiment of FIG. 1.

FIG. 3 is a sectional view of the embodiment of FIG. 1 illustrating a first configuration sealing a first inner diameter of a bottle neck/opening.

FIG. 4 is an exploded view of the bottle blender attachment of FIG. 1 in a second configuration.

FIG. 5 is a sectional view of the embodiment of FIG. 4 illustrating the second configuration sealing a second inner diameter of a bottle neck/opening, larger than the first inner diameter shown in FIG. 3.

FIG. 6 is a perspective view of another embodiment of a bottle blender attachment illustrating a conical member.

FIG. 7 is a sectional view of the bottle blender attachment of FIG. 6 illustrating a first configuration sealing a first inner diameter of a bottle neck/opening.

FIG. 8 is a sectional view of the bottle blender attachment of FIG. 6 illustrating a second configuration sealing a second inner diameter of a bottle neck/opening, larger than the first inner diameter shown in FIG. 7.

FIG. 9 is a perspective view of another embodiment of a bottle blender attachment illustrating an inflating member.

FIG. 10 is a sectional view of the bottle blender attachment of FIG. 9 illustrating a first configuration sealing a first inner diameter of a bottle neck/opening.

FIG. 11 is a sectional view of the bottle blender attachment of FIG. 9 illustrating a second configuration sealing a second inner diameter of a bottle neck/opening, larger than the first inner diameter shown in FIG. 10.

FIG. 12 is a perspective view of another embodiment of a bottle blender attachment illustrating a compressible member.

FIG. 13 is a sectional view of the bottle blender attachment of FIG. 12 illustrating a first configuration sealing a first inner diameter of a bottle neck/opening.

FIG. 14 is a sectional view of the bottle blender attachment of FIG. 12 illustrating a second configuration sealing a second inner diameter of a bottle neck/opening, larger than the first inner diameter shown in FIG. 13.

### DETAILED DESCRIPTION

Numerous variations and modifications will be apparent to one of ordinary skill in the art, as will become apparent from the description below. Therefore, the invention is not limited to the specific implementations discussed herein.

The embodiments of the bottle blender attachment/adaptor/assembly 20, or portions thereof, discussed hereinafter will focus on the implementation of the hereinafter-described techniques and apparatuses within a device and/or appliance such as a blender 10, or in other similar applications. However, it will be appreciated that the herein-described techniques and apparatuses may also be used in connection with other types of appliances/devices having mixing volumes/compartments/spaces/blades in some embodiments.

In some implementations, the bottle blender attachment 20, or portions thereof, may allow the user to utilize a variety of personal bottles/containers 15 (e.g. different openings) to engage the blender 10, or portions thereof. The bottle blender attachment 20 (e.g. bottle adaptor(s), blade assembly, blade) may include the mating features to engage one or more interfaces of the blender (e.g. blender base 11, drive mechanism 12, safety shut-off). The mating features, if used, may include, but are not limited to, the drive shaft/mechanism 31, anti-rotation features 32, bearings, bushings, and/or safety power shut-off switch of the blender/base, etc. The bottle blender attachment 20, blade assembly 22, and/or bottle adaptor 30 (e.g. drive shaft 31) may releasably engage the drive mechanism 12 and/or other features of the base 11 of the blender 10. The mating feature(s) may be incorporated in at least one bottle adaptor (e.g. first).

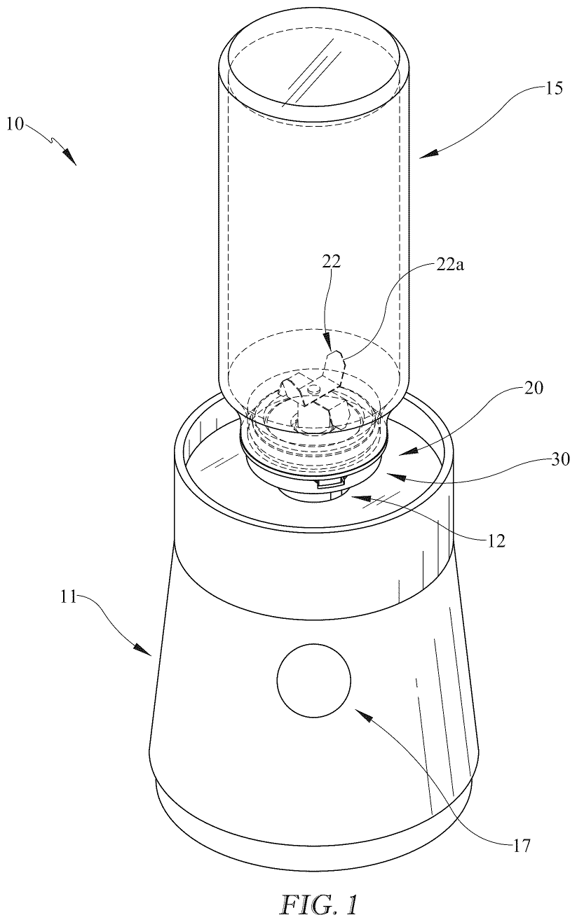

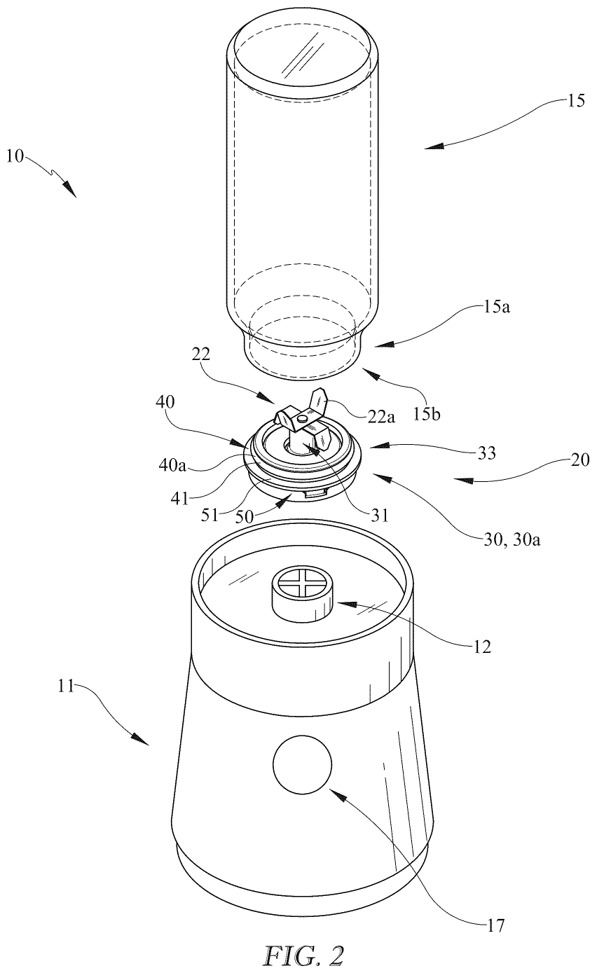

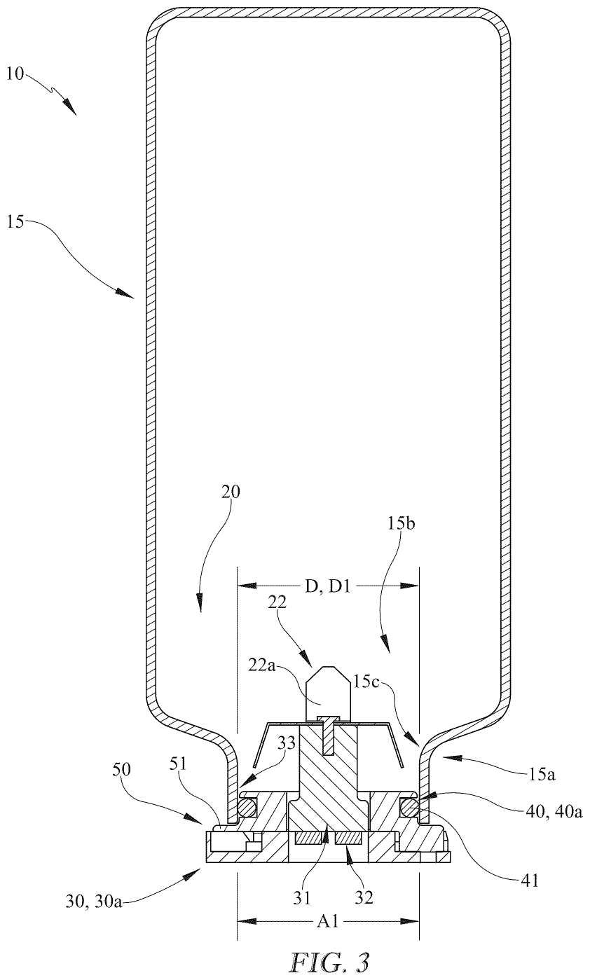

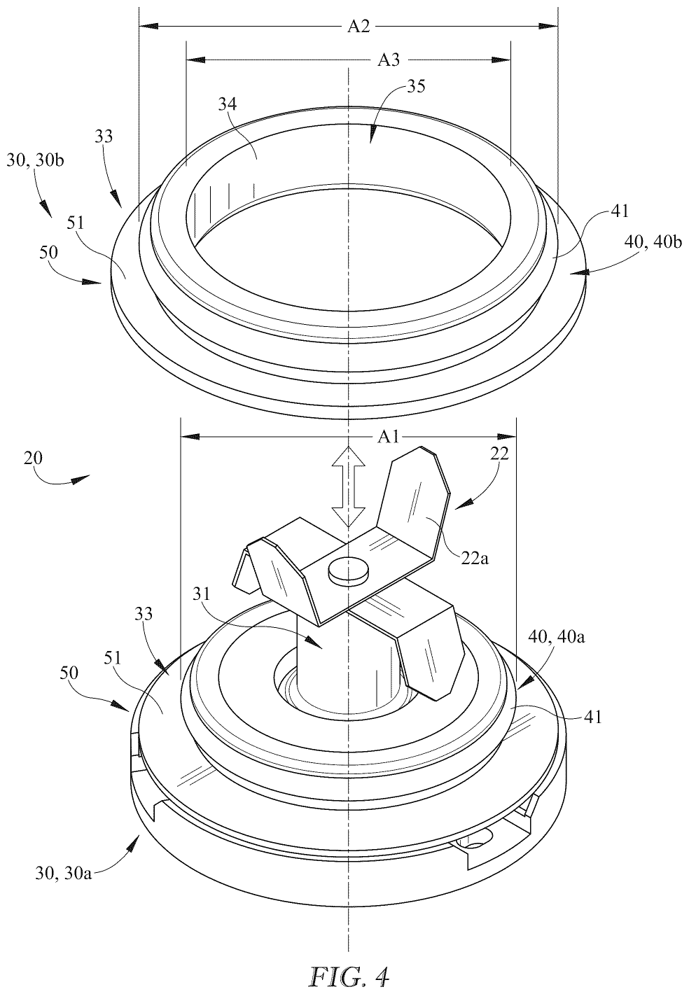

In some implementations, the bottle blender attachment 20, or portions thereof, (e.g. adaptor(s), sealing mechanism(s)) may releasably engage or be configured to seal one or more bottle necks 15a/openings 15b having a variety of and/or varying of diameters D (e.g. inner). A bottle neck 15a and/or opening 15b may have an inner diameter D that may vary along its length or axis of the opening 15b. The user may have multiple bottles 15 having a variety of inner diameters D or different openings in which it is desired to mix contents within. For example, the first bottle/opening/diameter D1 (e.g. inner) may be different from another or second bottle/opening/diameter D2 (e.g. inner). For example, a first bottle 15 may have a first neck/inner diameter D1, a second bottle 15 may have a second neck/inner diameter D2, a third bottle 15 may have a third neck/inner diameter, etc. The bottle blender attachment 20 may be positionable or configured between a first configuration and a second configuration. When in the first configuration as shown in FIGS. 1, 2, 3, 6, 7, 9, 10, 12, and 13, the bottle blender attachment 20 or at least one sealing mechanism 40 (e.g. first, second, third, etc.) may be configured to seal a bottle neck 15a (e.g. opening 15b, first, second) having a first inner diameter D1. The first inner diameter D1 may be a specific diameter or the first configuration may be used for a range of first inner diameters D1. For example when in the first configuration, the bottle blender attachment 20 may seal inner diameters (e.g. D1) of the range of about 2 inches to about 2.25 inches. When in the second configuration as shown in FIGS. 4, 5, 6, 8, 11, and 14, the bottle blender attachment 20 or at least one sealing mechanism 40 (e.g. first, second, third, etc.) may be configured to seal a bottle neck 15a (e.g. opening 15b, first, second) having a second inner diameter D2 larger than the first inner diameter D1. The second inner diameter D2 may be a specific diameter or the second configuration may be used for a range of second inner diameters. For example when in the second configuration, the bottle blender attachment 20 may seal inner diameters D2 of the range of about 2.25 inches to about 2.5 inches. With the neck 15a (e.g. inner diameter) of the bottle 15 (e.g. first, second, third, etc.) sealed (e.g. radially), the user may releasably engage the combined bottle blender attachment 20 and bottle 15 to the blender base 11 to operate the blade assembly 22, or portions thereof, to mix the contents of the bottle. Once completed/blended, the user may remove the bottle blender attachment (e.g. one or more adaptors) from the bottle to utilize the bottle 15 and/or corresponding bottle cap (not shown) to consume or use the blended contents contained therein. It should be understood that the bottle blender attachment 20 or sealing mechanism (e.g. member) may radially seal/interfere with the inner diameter D1, D2 when axially engaging at least a portion of the bottle opening/neck. Alternatively in some embodiments, the bottle blender attachment 20 or sealing mechanism (e.g. member) may not radially seal/interfere with the inner diameter D1, D2 when axially engaging at least a portion of the bottle opening/neck such that the sealing mechanism is subsequently configured (e.g. inflated, axial compressed) to seal the inner periphery or inner diameter of the bottle neck/opening. For example, the sealing mechanism or attachment may be configured to be axially inserted and then positioned (e.g. compressed, inflated) into engagement with (e.g. first configuration, second configuration, etc.) or seal with the inner diameter or opening of the bottle neck and/or another bottle adaptor. It should be understood that the bottle adaptor(s) and/or sealing mechanism(s) may seal/engage the distal free end of the bottle neck 15a and/or outer periphery/diameter of the bottle neck 15a alone or in combination with the inner periphery/diameter of the bottle neck in some embodiments. For example, in some embodiments, the bottle adaptor(s) and/or sealing mechanism(s) may only seal the inner diameter of the bottle neck/opening. For example, in some embodiments, the bottle adaptor(s) and/or sealing mechanism(s) may only seal the outer diameter of the bottle neck/opening. For example, in some embodiments, the bottle adaptor(s) and/or sealing mechanism(s) may seal the inner diameter and distal free end of the bottle neck/opening. For example, in some embodiments, the bottle adaptor(s) and/or sealing mechanism(s) may seal the inner diameter, outer diameter, and distal free end of the bottle neck/opening. For example, in some embodiments, the bottle adaptor(s) and/or sealing mechanism(s) may seal the outer diameter and distal free end of the bottle neck/opening.

In the one embodiment shown, the blender 10, if used, may include a base 11 with a drive mechanism 12 (e.g. motor). The bottle 15 and/or bottle neck 15a may include an interior/opening 15b defined by one or more surfaces (e.g. inner periphery). The blade assembly 22 (e.g. blade) and/or drive shaft 31 may be engageable (e.g. releasably) to the drive mechanism 12. The bottle/container 15 may be removably attached to the base 11. Control over blender 10 by a user is generally managed through a control panel or controls 17 typically disposed on a top or front of base 11, and it will be appreciated that in different blender designs, the control panel 17 may include various types of input and/or output devices, including various knobs, buttons, lights, switches, textual and/or graphical displays, touch screens, etc. through which a user may select/configure one or more settings and start/stop one or more blending cycles (e.g. clockwise rotation, counterclockwise rotation, mix) of the blender.

In some implementations, the blade assembly 22, or portions thereof, may include one or more blades 22a (e.g. first, second, etc.). In some embodiments, one or more bushings and/or one or more washers may be used. The draft shaft 31 may be coupled with the blade 22a and/or blade assembly 22. In some embodiments, the bottle adaptor 30 and/or first bottle adaptor 30a may include the blades/assembly 22a, 22, anti-rotation 32, and/or drive shaft 31.

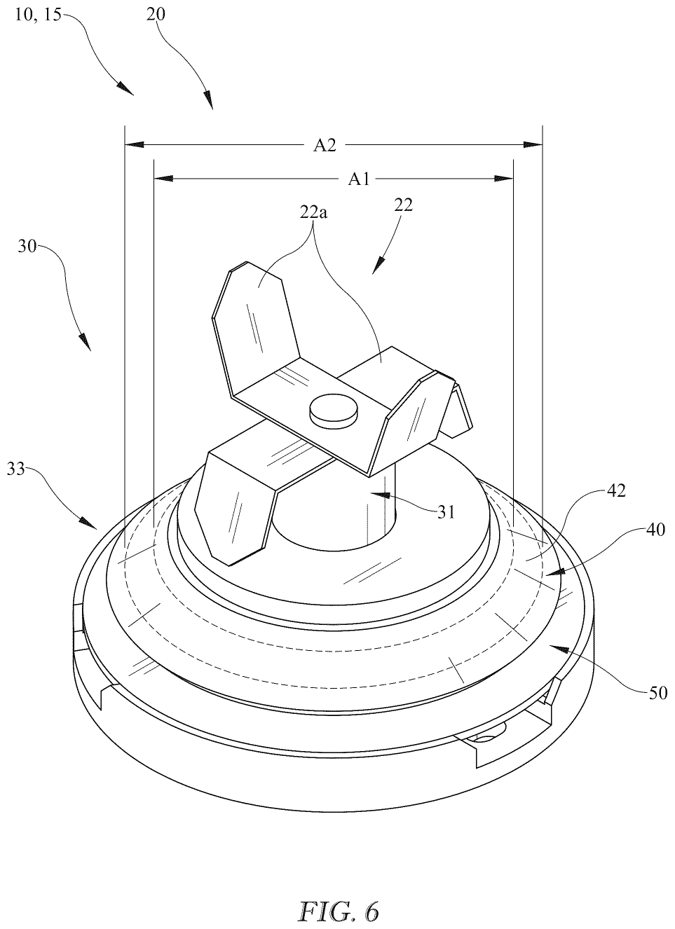

In some implementations, the bottle blender attachment 20 and/or bottle adaptor(s) 30 (e.g. first, second, etc.), or portions thereof, may include one or more sealing mechanisms 40. The one or more sealing mechanisms 40 and/or bottle adaptor 30 (e.g. first, second, third, etc.) may seal or radially engage the inner periphery 15c/diameter D (e.g. first, second, third, etc.) of the one or more bottle necks/openings. In some implementations, the sealing mechanism 40 (e.g. sealing surface) may be made of a material such as, but is not limited to, a soft rubber or silicone. In some embodiments as shown in FIGS. 6-14, a single sealing mechanism 40 and/or a single bottle adaptor 30 may be used to sealingly engage the bottle neck(s)/opening(s) (e.g. in both the first and second configurations). In some embodiments as shown in FIGS. 1-5, a plurality of sealing mechanisms 40 (e.g. 41, 42, 43, 44, etc.) and/or a plurality of bottle adaptors 30 may be used to sealingly engage the bottle neck(s)/opening(s) (e.g. in the first configuration or the second configuration).

In some implementations, the bottle blender attachment 20, bottle adaptor(s) 30, and/or sealing mechanism(s) 40 (e.g. at least one sealing member) includes an outer periphery 33 adjustable between at least one first configuration and at least one second configuration. The one or more sealing member 40 and/or bottle adaptor 30 (e.g. outer periphery 33) may be adjusted between at least a first configuration and at least a second configuration. When in the first configuration the outer periphery 33 of at least one sealing member 40 and/or bottle adaptor 30 may include a first diameter A1 (e.g. outer) sealingly engaging the inner diameter D of a bottle neck/opening. When in the second configuration the outer periphery 33 of at least one sealing member 40 and/or bottle adaptor 30 may include a second diameter A2 (e.g. outer), larger than the first outer diameter A1, sealingly engaging an inner diameter D of a bottle neck/opening. It should be understood that radial compression/expansion of the sealing member/mechanism 40 caused by radial inward/outward forces, or lack thereof, from the inner periphery of the bottle neck/opening (e.g. when inserting) does not constitute adjusting the sealing member/mechanism and/or bottle adaptor outer periphery between the first configuration and the second configuration. Alternatively stated, the radial compression/expansion of the sealing mechanism 40 caused by radial inward/outward forces, or lack thereof, of the inner periphery of the bottle neck/opening to create the interference sealing contact may occur in the first configuration and/or second configuration of the sealing member/mechanism and/or bottle adaptor(s). In some implementations, the one or more sealing members/mechanisms 40 and/or adaptor(s) (e.g. 30, 30a, 30b, etc.) may include an O-ring(s) 41, a conical member(s) 42, a compressible/expanding member(s) 43, and/or an inflating member(s) 44.

As shown in the one embodiment in FIGS. 1-5, the bottle blender attachment 20 and/or bottle adaptor(s) 30 may include a first bottle adaptor 30a and/or a second bottle adaptor 30b. The one or more bottle adaptors 30 may include one or more sealing mechanisms 40. The one or more bottle adaptors 30/sealing mechanisms 40 are configured to seal the bottle neck(s) 15a/opening(s) 15b, alone or in combination with each other, and/or provide blending/mixing within the bottle/container. The first bottle adaptor 30a may include a first sealing mechanism 40a. The first bottle adaptor 30a may include the blade assembly 22, or portions thereof. The outer periphery 33 of the first bottle adaptor 30a may include the first sealing mechanism 40a (e.g. O-ring, conical member, compression member, inflatable member). The blade assembly 22 may include blades 22a positioned on a first/top side of the adaptor 30 and the drive shaft 31/anti-rotational mechanism 32 on the second/bottom/opposing side of the adaptor. The second bottle adaptor 30b may include a second sealing mechanism 40b. The outer periphery 33 of the second bottle adaptor 30b may include the second sealing mechanism 40b (e.g. O-ring, conical member, compression member, inflatable member). The second bottle adaptor 30b may include an inner periphery 34/opening 35/diameter D3. The inner periphery 34 may define the opening 35. Although the first sealing mechanism 40a and the second sealing mechanism 40b are shown as the same (e.g. O-ring), the sealing mechanism of two bottle adaptors may be different. For example in some embodiments, the outermost or second sealing mechanism 40b may be inflatable, compressible, etc. different from the O-ring as shown. For example in some embodiments, the innermost or first sealing mechanism 40a may be inflatable, compressible, etc. different from the O-ring as shown. The sealing mechanism (e.g. first, second, etc.) may extend 360 degrees about the outer periphery as shown, although other positions/portions are contemplated.

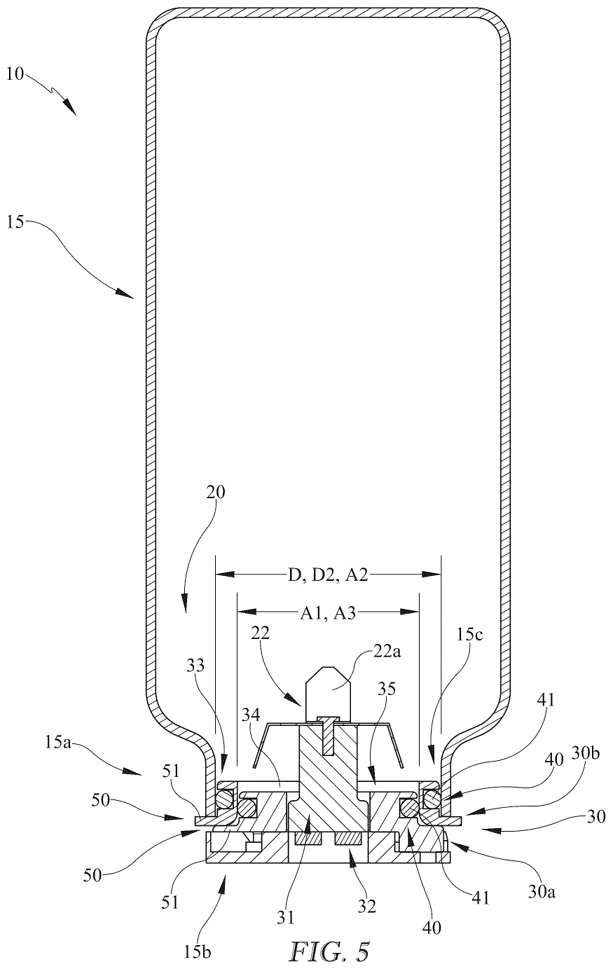

In some implementations, the first bottle adaptor 30a may be used to radially engage or seal the inner diameter(s) D (e.g. first D1, first range) of one or more bottle necks 15a/openings 15b and/or radially engage or seal the second bottle adaptor 30b (e.g. inner diameter/periphery 34, third inner diameter A3, another inner diameter), if used. Although two bottle adaptors are shown in the one embodiment in FIG. 4, more than two bottle adaptors may be used in some applications. Depending on the size of the bottle opening, a single bottle adaptor 30 (e.g. first) may be used to seal/blend the bottle(s)/opening(s) having one or more sizes. The single or first bottle adaptor 30, 30a may be positioned in the first configuration. When in the first configuration as shown in FIGS. 1-3, the first sealing mechanism 40a may be configured to radially engage a first inner diameter D1 of the one or more bottle necks/openings. In applications where the size of the bottle opening 15b is larger than the first bottle adaptor 30a (e.g. outer periphery 33, first outer diameter A1) may seal or be used, a second or plurality of bottle adaptors 30, 30b may be used in combination with the first bottle adaptor 30a to seal/blend the bottle(s)/opening(s) having one or more larger opening sizes/diameter D2. The first bottle adaptor 30a and second bottle adaptor 30b may be positioned in the second configuration. When in the second configuration as shown in FIGS. 4 and 5, the first sealing mechanism 40a or first bottle adaptor 30a may be configured to radially engage an inner periphery/opening/diameter (e.g. third A3) of the second bottle adaptor 30b or seal with the second bottle adaptor. When in the second configuration, the second sealing mechanism 40b or outer periphery 33 may be configured to radially engage a second inner diameter D2 of one or more bottle necks/openings larger than the first inner diameter. The second bottle adaptor 30b, if used, may be used to radially engage or seal the inner diameter(s) D (e.g. second, second range) of one or more bottle necks/openings. The second range or diameter may be larger than the first range or diameter. The first range and second range may overlap in some embodiments. The inner periphery 34/opening 35 of the second bottle adaptor 30b, if used, may be sealed or radially engaged by the first bottle adaptor 30a or first sealing mechanism 40a. The first bottle adaptor 30a, or portions thereof, may telescope into or telescopingly engage the inner periphery 34/opening 35/diameter (e.g. third A3) of the second bottle adaptor 30b, if used, when in the second configuration. This may seal (e.g. radially) the inner periphery 34 of the second bottle adapter 30b. Although not shown, it should be understood that an additional or third bottle adaptor(s) (e.g. having a third inner periphery) may be used to seal between the second bottle adaptor and bottle neck/opening inner periphery.

In the one embodiment shown in FIGS. 6-14, the bottle blender attachment 20, bottle adaptor 30, and/or sealing mechanism 41 (e.g. first, single) may be configured to seal or positioned in both a first configuration and a second configuration in some applications. In the one embodiment shown in FIGS. 6-14, the sealing mechanism 40 (e.g. single) may engage a range of inner diameters D (e.g. D1, D2, between D1 and D2, D3, etc.) of the bottle neck(s)/opening(s). The sealing mechanism 40 and/or outer periphery 33 (e.g. diameter) of the sealing mechanism or bottle adaptor (e.g. single) may radially change (e.g. increase, decrease) to seal a variety of diameters of the necks 15a/openings 15b. The sealing mechanism 40 or outer diameter/periphery 33 may be increased and/or decreased. Alternatively stated, the outer periphery 33 is not fixed to one configuration.

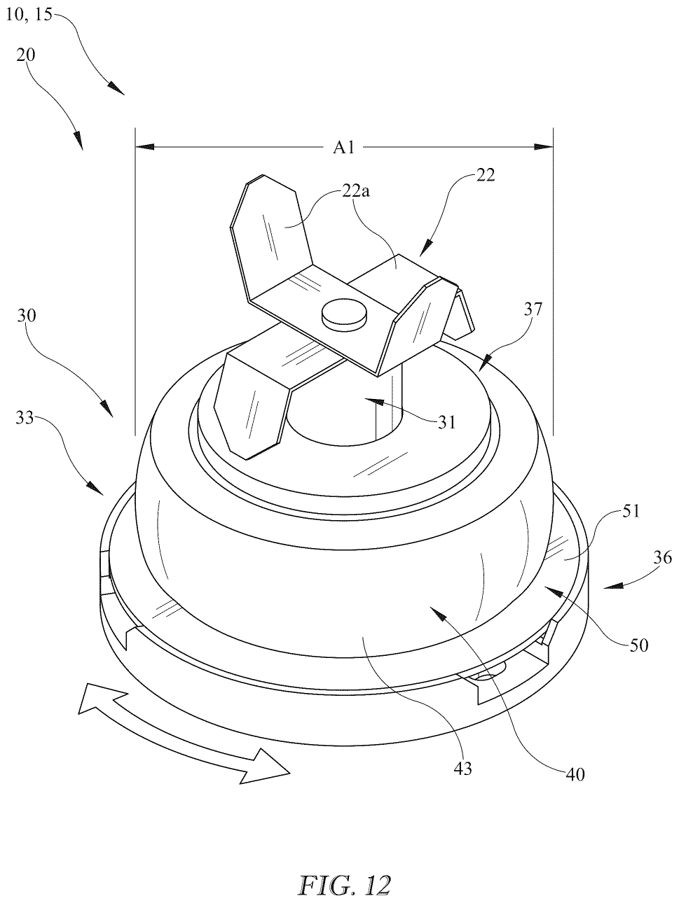

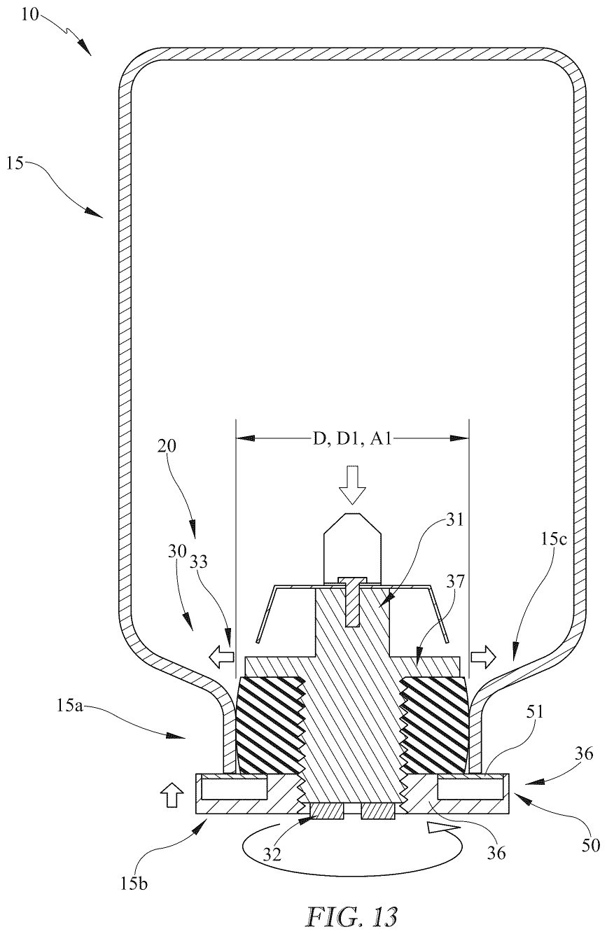

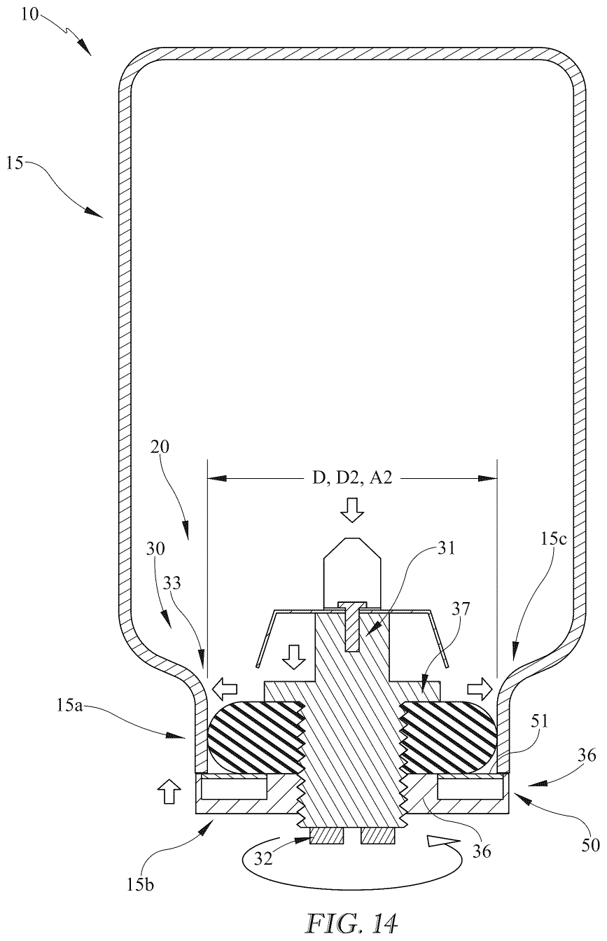

In the one embodiment shown in FIGS. 12-14, the sealing mechanism 40 (e.g. first, member) may be compressible (e.g. axially). The sealing mechanism 40 or compressible member 43 may be axially compressed or uncompressed to vary the outer diameter/periphery 33 of the seal member or bottle adaptor. The compression is applied substantially perpendicular to the direction (e.g. radial) of the sealing surface/contact and/or increasing/decreasing diameter. As shown in FIG. 14, the sealing mechanism 40 (e.g. 40a, 40b) or compressible member 43 may be axially compressed to increase the outer diameter/periphery 33 from at least a first outer diameter A1 to at least a second outer diameter A2 larger than the first outer diameter. Further, as shown in FIG. 13, the sealing mechanism 40 or compressible member 43 may be axially uncompressed to decrease the outer diameter/periphery from the second outer diameter A2 to the smaller first outer diameter A1. The first outer diameter A1 may seal in the first configuration (e.g. D1) and the second outer diameter A2 may seal in the second configuration (e.g. D2). In the one embodiment shown, a portion 36 of the bottle adaptor 30 (e.g. blade assembly) may be axially moved (e.g. threaded) relative to another portion 37 of the bottle adaptor to adjust the compression (e.g. axial) of the sealing mechanism 40 (e.g. 43) to vary the outer diameter/periphery. For example, increasing the distance between portions 36 and 37 decreases the axial compression of the seal member 43 and results in the decrease in the diameter A1 or outer periphery 33. Further for example, decreasing the distance between portions 36 and 37 increases the axial compression of the seal member 43 and results in the increase in the diameter A2 or outer periphery 33.

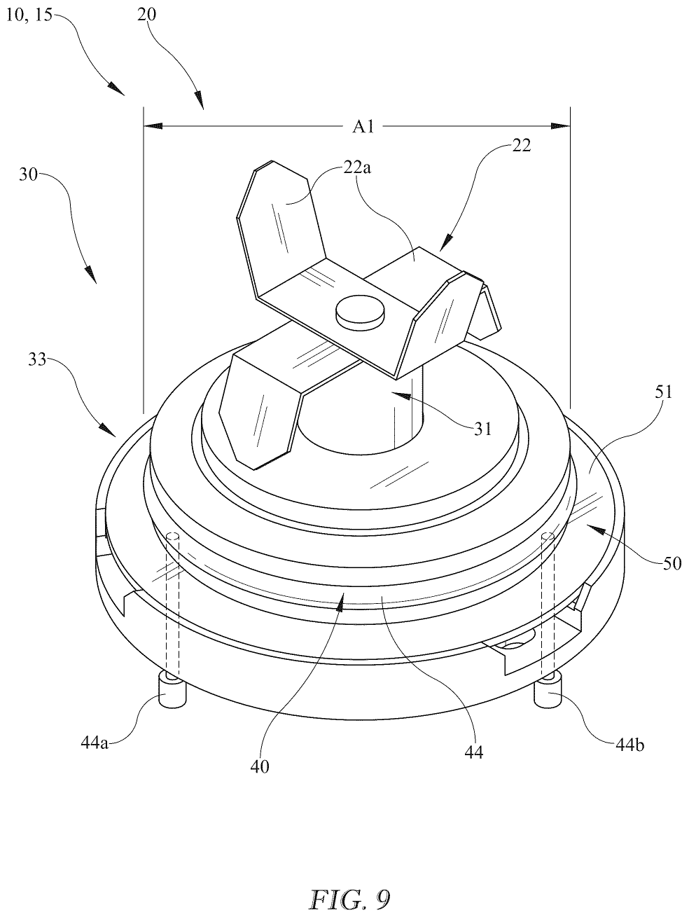

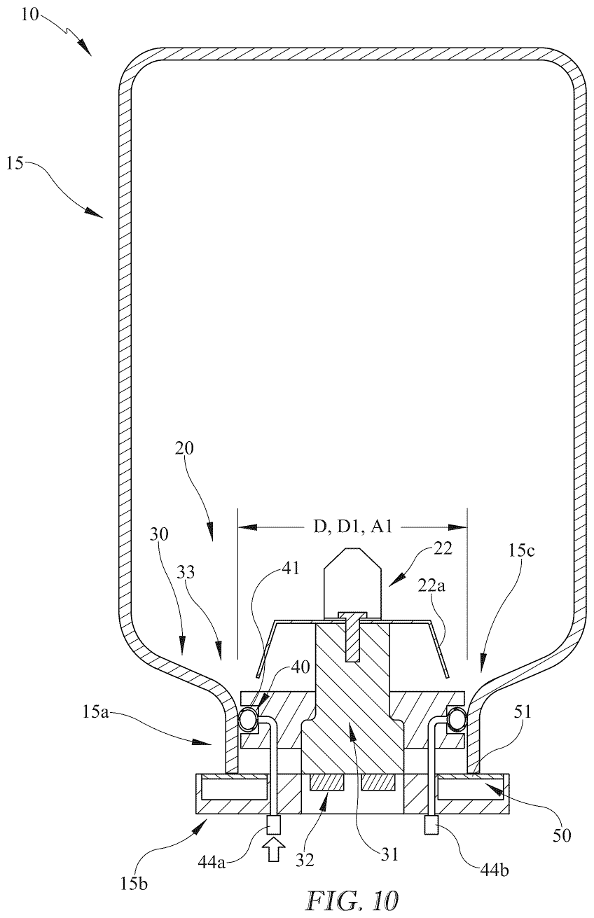

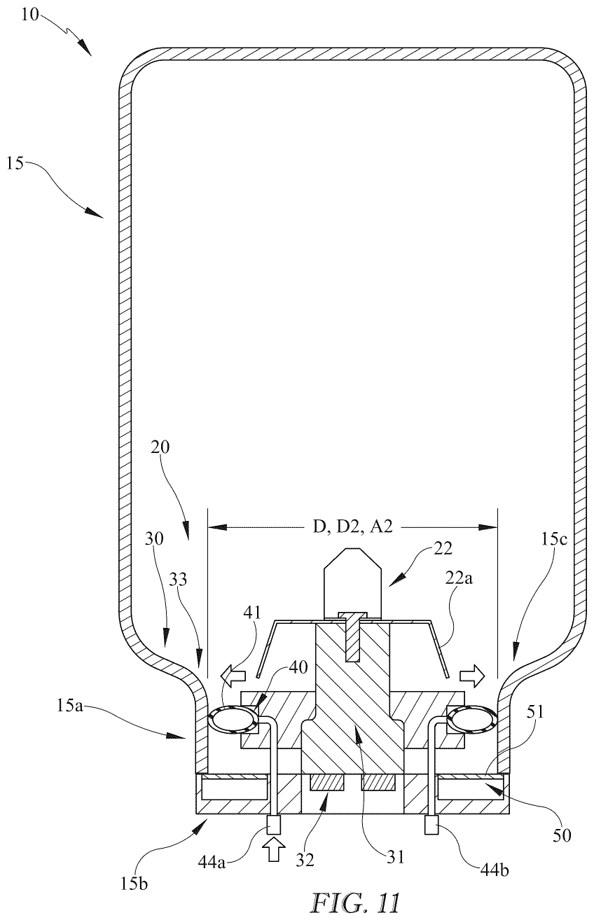

In the one embodiment shown in FIGS. 9-11, the sealing mechanism 40 (e.g. first, member 44) may be inflatable/deflatable. As shown in FIG. 11, the sealing mechanism 40 (e.g. 40a, 40b) or inflating member 44 may be inflated to increase the outer diameter/periphery 33 from at least one first outer diameter A1 to at least one second outer diameter A2 larger than the first outer diameter. Further, as shown in FIG. 10, the sealing mechanism 40 or inflating member 44 may be deflated to decrease the outer diameter/periphery 33 from the second outer diameter A2 to the smaller first outer diameter A1. The first outer diameter A1 or periphery 33 may seal in the first configuration (e.g. D1) and the second outer diameter A2 or periphery 33 may seal in the second configuration (e.g. D2). The bottle adaptor may include a pump system 44a, if used, (e.g. pump air into sealing member) and/or valve system 44b, if used, (e.g. open or close one or more valves) to inflate/deflate the seal mechanism or inflating member 44.

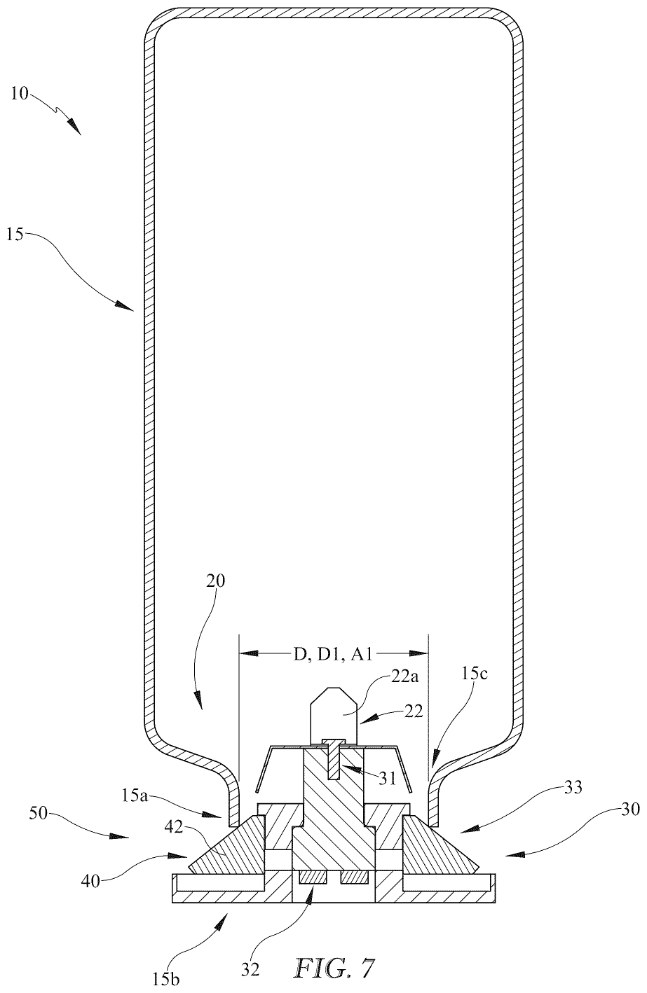

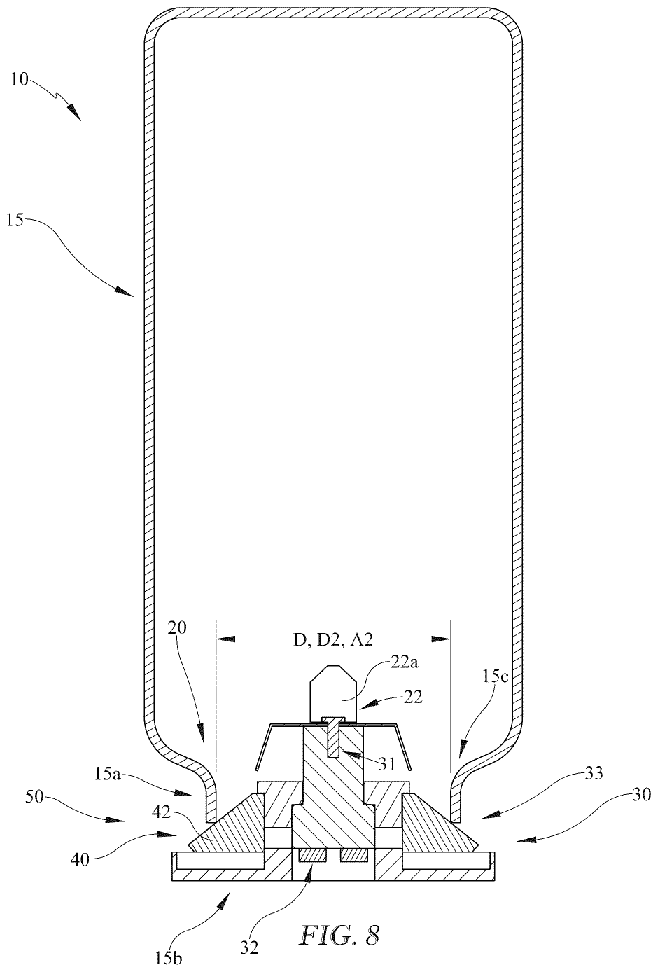

As shown in the one embodiment in FIGS. 6-8, the sealing mechanism 40 (e.g. first, member 42) may be conical in shape. The sealing mechanism 40 (e.g. 40a, 40b) or conical member 42 may include a substantially conical outer periphery 33. The conical outer periphery 33 may narrow in a direction towards the blades 22a and/or blade assembly 22. The bottle adaptor 30 and/or sealing mechanism 40, 42 may be axially inserted into the bottle neck/opening to engage the conical outer periphery 33 with at least the inner periphery 15c of the bottle neck 15a/opening 15b. Although not shown, the distal free end of the bottle neck 15a and/or outer periphery of the bottle neck 15a may be engaged/sealed alone or in combination with the inner periphery of the bottle neck in some embodiments. As shown in FIG. 8, the larger the opening 15b, the more the adaptor/member 42 is axially inserted into the bottle neck/opening. The larger the opening 15b or when in the second configuration (e.g. D2), the neck/opening engages at least one larger diameter A2 along the conical surface of the outer periphery 33. As shown in FIG. 7, the smaller the opening 15b the less the adaptor/member 42 is axially inserted into the bottle neck/opening. The smaller the opening or when in the first configuration (e.g. D1), the neck/opening engages at least one smaller diameter A1 along the conical surface of the outer periphery 33. The conical outer periphery/member and/or seal mechanism may stop or limit the axial insertion/travel into the bottle neck/opening. As shown in the one embodiment in FIGS. 6-8, the axial stopping mechanism 50, if used, may be the conical outer periphery 33 and/or member 42 (e.g. conical) of the sealing mechanism 40.

In some implementations, the bottle blender attachment 20 and/or bottle adaptor(s) 30 (e.g. first, second, etc.), or portions thereof, may include an axial stopping mechanism 50. The axial stopping mechanism 50, if used, may be configured to stop or limit the axial travel/insertion of a bottle adaptor 30 (e.g. first) relative to the bottle neck 15a/opening 15b and/or to another bottle adaptor 30 (e.g. second). The axial travel/insertion may be limited or stopped in the first configuration and/or second configuration. As shown in the figures, the bottle adaptor 30 (e.g. first, second, etc.) may include one or more axial stopping mechanisms 50. As shown in FIGS. 1-5 and 9-14, the axial stopping mechanism 50, if used, may be one or more flanges 51. In some embodiments as shown in FIGS. 6-8, the sealing mechanism may include the axial stopping mechanism. The outwardly projecting flange 51 may project from the side or periphery of the adaptor adjacent the drive shaft 31 (e.g. distal free end)/blender base/anti-rotation features 32 or opposite the blades 22a. As shown in FIGS. 1-5, both the first bottle adaptor 30a and the second bottle adaptor 30b may include one or more axial stopping mechanisms 50. The first bottle adaptor 30a may include an axial stopping mechanism 50 (e.g. flange, first) that when in the first configuration both axial stops or limits axial insertion of the first bottle adaptor 30a into the bottle opening 15b when a second bottle adaptor 30b is not needed as shown in FIGS. 1-3. The first bottle adaptor 30a may include an axial stopping mechanism 50 (e.g. flange, first) that when in the second configuration axial stops or limits axial insertion of the first bottle adaptor 30a into the second bottle adaptor opening 35 when a second bottle adaptor 30b is used as shown in FIGS. 4 and 5. The axial stopping mechanism 50 (e.g. flange) of the second bottle adaptor 30b, if used, may axial stop or limit axial insertion of the both the first bottle adaptor 30a and second bottle adaptor 30b into the bottle opening as shown in FIG. 5.

In use, the user may provide one or more contents into the bottle/container 15. The user may then insert (e.g. axially) the bottle blender attachment 20 and/or bottle adaptor(s) 30 (e.g. 30a, 30b) into the bottle opening 15b/neck 15a in one or more configurations. The blade(s) 22a or top of the bottle adaptor(s) may be facing or interior of the bottle neck/opening. In some configurations, the bottle adaptor(s) (e.g. outermost adaptor, outer periphery 33, seal mechanism 40, O-ring 41) may be compressed inwardly by the interference with the bottle neck 15a/opening 15b. For example, the O-ring 41 or inflating tube/member 44 (e.g. first configuration, second configuration) may seal or be compressed when inserted. In some configurations, the bottle adaptor(s) (e.g. outermost adaptor, outer periphery 33, seal mechanism) may be expanded to interfere/seal with the bottle neck/opening after inserting. For example, if the inflating or compressible sealing member 44, 43 does not already seal against the neck opening 15b when inserted, the sealing mechanism may be inflated or axially compressed to seal the bottle neck/opening after insertion. In a first configuration, the bottle adaptor(s) and/or sealing mechanism(s) may sealingly engage the first inner diameter D1 of a bottle neck/opening (e.g. first). In a second figuration, the bottle adaptor(s) and/or sealing mechanism(s) may sealingly engage the second inner diameter D2 of a bottle neck/opening (e.g. second) larger than the first inner diameter. The user may inflate at least one sealing mechanism 40 (e.g. outer, inner, inflating member 44) from the first configuration to the second configuration. The user may deflate at least one sealing mechanism 40 (e.g. outer, inner, inflating member 44) from the second configuration to the first configuration. The user may compress (e.g. axially, thread portions relative to each other) at least one sealing mechanism 40 (e.g. outer, inner, compressible member 43) from the first configuration to the second configuration. The user may uncompress (e.g. axially, reverse thread portions relative to each other) at least one sealing mechanism 40 (e.g. outer, inner, compressible member 43) from the second configuration to the first configuration. In some embodiments, the user may axially insert the bottle adaptor 30 into the bottle neck/opening in a first configuration or a second configuration. If the bottle adaptor includes a first bottle adaptor 30a and a second bottle adaptor 30b, the user may assemble together before insertion. Alternatively in some embodiments, bottle adaptors (e.g. first) may be assembled after at least one adaptor (e.g. second) has been inserted in the opening. When in the second configuration, the first bottle adaptor 30a (e.g. first sealing mechanism, etc.) may sealingly engage (e.g. telescope) the second bottle adaptor 30b (e.g. adaptor inner diameter A3) and/or the second bottle adaptor 30b sealingly engages the second inner diameter D2. Further, in some embodiments, the user may telescopingly engage the first bottle adaptor 30a with the second bottle adaptor 30b. One or more axial stopping mechanisms 50 of one or more bottle adaptors 30 (e.g. first, second) may limit or stop axial inserting of the one or more adaptors (e.g. seal mechanisms) into the bottle opening 15b/neck 15a. In some embodiments, one or more axial stopping mechanisms may limit or stop axial insertion between bottle adaptors.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A blender for engaging one or more bottle openings of a variety of inner diameters comprising:
a base having a drive mechanism;
a bottle blender attachment configured to engage one or more bottle openings of a variety of inner diameters, the bottle blender attachment having a blade assembly and a first bottle adaptor, wherein the blade assembly releasably engages the drive mechanism of the base; and
wherein the first bottle adaptor includes a first sealing mechanism configured to radially engage a first inner diameter of the one or more bottle openings.

2. The blender of claim 1 further comprising a second bottle adaptor having a second sealing mechanism, wherein the first sealing mechanism is configured to radially engage the second bottle adaptor and the second sealing mechanism is configured to radially engage a second inner diameter larger than the first inner diameter of the one or more bottle openings.

3. The blender of claim 2 wherein the first sealing mechanism is the same as the second sealing mechanism.

4. The blender of claim 2 wherein the first bottle adaptor telescopes within the second bottle adaptor.

5. The blender of claim 2 wherein the second bottle adaptor includes an axial stopping mechanism configured to axially stop insertion of the second bottle adaptor into the one or more bottle openings.

6. The blender of claim 1 wherein the first sealing mechanism is an O-ring.

7. The blender of claim 1 wherein the first bottle adaptor includes an axial stopping mechanism configured to axially stop insertion of the first bottle adaptor into at least one of the one or more bottle openings and/or a second bottle adaptor.

8. The blender of claim 1 wherein the first sealing mechanism is inflatable, wherein the first sealing mechanism is inflated to increase a first outer diameter to a second outer diameter larger than the first outer diameter.

9. The blender of claim 1 wherein the first sealing mechanism is compressible, wherein the first sealing mechanism is axially compressed to increase a first outer diameter to a second outer diameter larger than the first outer diameter.

10. The blender of claim 1 wherein the first sealing mechanism includes a conical outer periphery, wherein the conical outer periphery narrows in a direction towards the blade assembly.

11. A bottle blender attachment for engaging one or more bottle openings of a variety of inner diameters comprising:
a blade assembly configured to releasably engage a drive mechanism of a blender; and
a first bottle adaptor having a first sealing mechanism, wherein the first bottle adaptor is positionable between a first configuration and a second configuration, wherein when in the first configuration the first sealing mechanism is configured to radially engage a first inner diameter of one or more bottle openings and wherein when in the second configuration the first sealing mechanism is configured to radially engage a third inner diameter of a second bottle adaptor.

12. The bottle blender attachment of claim 11 wherein the first bottle adaptor includes an axial stopping mechanism to limit axial travel in the first configuration or the second configuration.

13. The bottle blender attachment of claim 11 further comprising a second bottle adaptor having a second sealing mechanism, wherein when in the second configuration the second sealing mechanism is configured to radially engage a second inner diameter of one or more bottle openings larger than the first inner diameter.

14. The bottle blender attachment of claim 13 wherein the first bottle adaptor telescopingly engages the third inner diameter of the second bottle adaptor when in the second configuration.

15. The bottle blender attachment of claim 13 wherein the second bottle adaptor includes an axial stopping mechanism to limit axial travel of the second bottle adaptor relative to one or more bottle openings.

16. The bottle blender attachment of claim 13 wherein at least one of the first sealing mechanism and/or the second sealing mechanism is an O-ring.

17. A bottle blender attachment for engaging one or more bottle openings of a variety of inner diameters comprising:
a bottle adaptor;
a blade assembly releasably engaging a drive mechanism of a blender;
wherein the bottle adaptor includes at least one sealing mechanism having an outer periphery adjustable between a first configuration and a second configuration, wherein when in the first configuration the outer periphery of the at least one sealing mechanism includes a first outer diameter sealingly engaging an inner diameter of a bottle opening and wherein when in the second configuration the outer periphery of the at least one sealing mechanism includes a second outer diameter, larger than the first outer diameter, sealingly engaging an inner diameter of a bottle opening; and
wherein the at least one sealing mechanism is an O-ring, a conical member, a compressible member, or an inflatable member.

18. A method of sealing one or more bottle openings of a variety of inner diameters comprising:
providing a bottle blender attachment having a blade assembly releasably engaging a drive mechanism of a blender and a bottle adaptor, wherein the bottle adaptor includes at least one sealing member having an outer periphery adjustable between a first configuration and a second configuration, wherein when in the first configuration the outer periphery of the at least one sealing member includes a first outer diameter and wherein when in the second configuration the outer periphery of the at least one sealing member includes a second outer diameter larger than the first outer diameter;
axially inserting the bottle adaptor into a bottle opening having a first inner diameter or a second inner diameter larger than the first inner diameter;
sealingly engaging the first inner diameter when in the first configuration; and
sealingly engaging the second inner diameter when in the second configuration.

19. The method of claim 18 further comprising inflating the at least one sealing member from the first configuration to the second configuration.

20. The method of claim 18 further comprising compressing the at least one sealing member from the first configuration to the second configuration.

21. The method of claim 18 further comprising axially inserting the bottle adaptor into the bottle opening from the first configuration to the second configuration.

22. The method of claim 18 wherein the bottle adaptor includes a first bottle adaptor and a second bottle adaptor, wherein when in the second configuration the first bottle adaptor sealingly engages the second bottle adaptor and the second bottle adaptor sealingly engages the second inner diameter.

23. The method of claim 22 further comprising telescopingly engaging the first bottle adaptor to the second bottle adaptor.
